(19) United States
(12) Patent Application Publication
(10) Pub. No.: US 2018/0122111 A1
(43) Pub. Date: May 3, 2018

(54) DATA VISUALIZATION REPRESENTATION FROM SERVICE

(71) Applicant: Microsoft Technology Licensing, LLC, Redmond, WA (US)

(72) Inventors: Jose Lara Silva, Seattle, WA (US); Kyle Thomas Blevens, Seattle, WA (US)

(21) Appl. No.: 15/387,040

(22) Filed: Dec. 21, 2016

Related U.S. Application Data
(60) Provisional application No. 62/416,099, filed on Nov. 1, 2016.

(51) Int. Cl. G06T 11/20; G06F 17/22; G06F 3/0484; G06F 17/30

(52) U.S. Cl. CPC G06T 11/206; G06F 17/2235; H04L 67/10; G06F 17/30572; G06F 17/30377; G06F 3/04842

(57) ABSTRACT

Non-limiting examples of the present disclosure describe examples of data visualization, where data visualization representations may be generated to visually represent aggregated data for a service from the perspective of a user. The data visualization representation aggregates data of the service into points of interest that provide user-centric perspectives of the service data. Points of interest may comprise but not limited to: individual data streams, channels pertaining to groups and/or teams that a user is associated with, messages, postings, mentions, chats/conversations, emails, meetings/events, social networking connections, documents, task items, reminders, data storage and media content, among other examples. An exemplary data visualization representation is designed to organize a large volume of service data for the user, direct attention of the user to content that may be of importance to the user as well as enable a user to initiate an action through the data visualization representation.

### CROSS REFERENCE TO RELATED APPLICATION(S)

This application is a Non-Provisional Patent Application of, and claims priority to, U.S. Provisional Patent Application No. 62/416,099, filed Nov. 1, 2016, entitled “DATA VISUALIZATION REPRESENTATION FROM SERVICE” which is incorporated herein by reference in its entirety.

### BACKGROUND

On-demand services typically inundate users with voluminous amounts of data. Large amounts of data present challenges with respect management and organization of data. Consider an example where a user is affiliated with multiple different groups across a service. As the number of groups (and participants within a group) increases, the amount of content that is shared among the groups increases exponentially. Among other issues, it becomes difficult for users to understand which groups have content that is immediately relevant for the users or where their contributions will impact a broader audience. As such, examples of the present application are directed to technical improvements related to content organization and management, for example, to improve operation of an application/service, among other examples.

### SUMMARY

Non-limiting examples of the present disclosure describe data visualization processing, for example, summarizing analysis of service data for a service. In one example, a service may be a distributed service that is utilized to access a variety of types of content. Service data may be collected for the distributed service. Service data may be data from one or more data channels of a service, for example, where a data channel may pertain to one or more groups that a user is associated with. Service data may be aggregated at a specific level (e.g. user level, group level, etc.) or multiple levels. Telemetry data may be generated for the aggregated service data. Telemetry data may be analyzed to generate an exemplary data visualization representation. In one instance, an exemplary data visualization representation may be generated from a perspective of a specific user (or multiple users). The data visualization may present, for a user, a collective representation of service data aggregated at one or more levels in real-time, where visual indications may be utilized to differentiate channels/streams, levels, specific and specific content, among other examples. Update to an exemplary data visualization representation may also occur in real-time, for example, where an automatic update to a data visualization representation may occur based on update to service data for a user.

As an example, an exemplary data visualization for the user may provide visual representation of a variety of content/data channels across a service that a user is associated with. For example, a user may be associated with 3 different groups, where the data visualization provides cross-references to content from all 3 of the example groups within a single representation. An exemplary data visualization representation may comprise a plurality of indications of points of interest across one or more data channels (e.g. pertaining to one or more groups). The plurality of indications of points of interest may vary by one or more of: scale, visual depiction and orientation based on a result of the analysis of the telemetry data. For instance, indications of points of interest pertaining to a specific data channel, group, team, etc. may be one color and indications of points of interest for another data channel, group, team, etc. may be a different color. Points of interest within a respective categorization (e.g. user, group, team, etc.) may also vary in scale, shape, font, orientation, visual depiction, etc. based on whether a user is to be notified of a specific point of interest. That is, characteristics of an exemplary point of interest may be customizable to alter display of the data visualization representation, for example, bring a point of interest to the attention of a user. Points of interest (and associated indications) may be updatable in real-time based on changes to service data and/or analysis of the service data. An exemplary data visualization representation may present a real-time visual representation of user data across a service where an update to service data may result in automatic re-generation of a data visualization representation for a user (or users).

In further examples, a data visualization representation may comprise an explicit notification that corresponds to an indication of the plurality of indications of points of interest. In at least one instance, a notification is presented in a foremost layer of the data visualization representation. For instance, an exemplary point of interest may be more identifiable than other points of interest within a data visualization representation, where a user may select, scroll over, etc. a specific point of interest. An exemplary data visualization service may be configured to display the explicit notification, for example, based on user action. In other examples, explicit notifications may be automatically displayed when a data visualization representation is generated, for example, based on analysis of telemetry data.

In another example, an exemplary data visualization representation is provided to a team of users. For instance, the data visualization representation may be provided to the team of users through the distributed service or other communication resource (e.g. messaging application, email, social networking service, etc.).

Moreover, generation/update of an exemplary data visualization representation may be managed in real-time for a user. As referenced above, an exemplary data visualization representation may be automatically updated based on an update to service data, for example, that is associated with one or more data channels of a distributed service. Update to a data visualization representation may result in reconfiguration and re-alignment of indications of points of interest from a previous version of a data visualization representation. In some examples, a new indication may be added where another indication of a point of interest may be removed. New data for a user that is associated with a service (e.g. content such as message, posting, email, etc.) may be received resulting in re-collection and re-analysis of the service data (and associated telemetry data). An updated data visualization representation may be generated based on re-analysis processing.

Further example provided relate to: management of service data, analysis of telemetry data and management of exemplary data visualization representations that may be presented to users of an exemplary service.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 is a block diagram illustrating an example of a computing device with which aspects of the present disclosure may be practiced.

FIGS. 2A and 2B are simplified block diagrams of a mobile computing device with which aspects of the present disclosure may be practiced.

FIG. 3 is a simplified block diagram of a distributed computing system in which aspects of the present disclosure may be practiced.

FIG. 4 provides examples of an exemplary method related to management of an exemplary data visualization representation with which aspects of the present disclosure may be practiced.

FIGS. 5A-5C are exemplary user interface views presenting exemplary data visualization representations with which aspects of the present disclosure may be practiced.

### DETAILED DESCRIPTION

Non-limiting examples of the present disclosure describe examples of data visualization, where data visualization representations may be generated to visually represent aggregated data for a service. As an example, an exemplary data visualization representation may present a visual representation of data of a service (e.g. service data) from the perspective of a user. The data visualization representation aggregates data of the service into points of interest that provide user-centric perspectives of the service data. Points of interest may comprise but not limited to: individual data streams, channels pertaining to groups and/or teams that a user is associated with, messages, postings, mentions, chats/conversations, emails, meetings/events, social networking connections, documents, task items, reminders, data storage and media content, among other examples. An exemplary data visualization representation is designed (and configured) to organize a large volume of service data for the user, direct attention of the user to content that may be of importance to the user as well as enable a user to initiate an action through the data visualization representation. The data visualization may present, for a user, a collective representation of service data aggregated at one or more levels in real-time, where visual indications may be utilized to differentiate channels/streams, levels, specific and specific content, among other examples. Update to an exemplary data visualization representation may also occur in real-time, for example, where an automatic update to a data visualization representation may occur based on update to service data for a user.

Exemplary points of interest, presented in a data visualization representation may pertain to a user account associated with a service (e.g. distributed service). A user account may be associated with one or more users. In one example, a user account is associated with a single user. In another example, a user account is associated with a group of users (e.g. group/team account). A user account may be specific to an exemplary service or alternatively may be associated with a platform that comprises a plurality of applications/services. A data visualization representation may be generated based on analysis of service data comprising collected telemetry data for a service. In one instance, service data may be aggregated at a specific level of analysis. For instance, telemetry data may be aggregated at a user-level, group-level and a content-level (e.g. data channel level), among other examples. Telemetry data may be generated for aggregated service data. Telemetry data may be analyzed for points of interest that pertain to specific data channels (e.g. identifications of: new content, categorization of existing content, deleted content, etc.). Analyzed telemetry data is used to determine: how to display a point of interest when an exemplary data visualization representation is generated as well as specific content to push for notification to a user (e.g. new message, upcoming meeting, tasks/reminders, etc.).

An exemplary data visualization representation prioritizes actions for a user based on updates to content of the service. Notifications of update to an exemplary point of interest may be provided through the data visualization representation. Update to a data visualization representation may comprise re-generation of exemplary points of interest (e.g. where position, color, shape, scale, orientation, etc.) and/or display of new points of interest. Moreover, a user may interact with a data visualization representation, for example, where an exemplary data visualization representation is configured to enable a user to take subsequent action within a service based on a representation provided of the service data. An exemplary data visualization representation provides a live, real-time view of different points of interest for the service in a manner that highlights areas that are most relevant to a specific user (or users). In one example, an exemplary data visualization representation may provide points of interest across different data channels associated with a user (e.g. different groups that a user is associated with). In examples, a point of interest may be automatically updated based on an update to service data or re-analysis of service data and/or collected telemetry data for a service. For instance, a user may select an exemplary point of interest or a notification provided through the data visualization representation, for example, to access content of the service.

As described above, a data visualization representation may comprise representation of points of interest that are of interest to a user. An exemplary point of interest may be affiliated with one or more endpoints for retrieving information about activity across a service. An exemplary endpoint may be associated with one or more data streams of the service. One example of a point of interest may be a channel that comprises one or more data streams of a service. In one instance, a channel may comprise data streams for a specific topic that is affiliated with a group/team. A user may be affiliated with a variety of teams, where it may be traditionally difficult to organize and manage large amounts of data. Examples of the present disclosure enable generation of an exemplary data visualization representation that assist a user in managing service data, for example, at a team/group level or multiple levels.

Moreover, an exemplary data visualization representation may present a visual representation resulting from analysis of service data (e.g. telemetry data generated from collected service data). In examples, a data visualization representation may be customizable to enable users to better management service data. In one example, an exemplary data visualization representation is provided through an active dashboard that enables a user to manage, through a user interface, service data pertaining to the user. In some examples, an exemplary data visualization representation may comprise a visual representation of service data aggregated at different levels. In one instance, service data associated with different data channels can be aggregated at a group level and individual user level (e.g. for users associated with the group), where indications of points of interest can be utilized to identify different levels of aggregation. In at least one example, an exemplary data visualization representation may be adjustable where multiple views may be generated for a single data visualization representation. A data visualization representation may be configured to enable a user to select different view of a data visualization representation, for example, a group level view, a user level view, a content specific view, etc. Furthermore, users can drill into specific data channels/streams, content, user profiles, etc. that may be associated with a data visualization representation.

Accordingly, the present disclosure provides a plurality of technical advantages including but not limited to: creation of an exemplary data visualization service within a native application/service, improved processing operations for aggregation and management of large amounts of data related to an application/service, generation of exemplary data visualization representations (in real-time or offline), more efficient operation of processing devices (e.g., saving computing cycles/computing resources) for management and update of data visualization representations, improved efficiency for management of service data of a service, improved user action between a user and a service, and extensibility to integrate processing operations described herein in a variety of different applications/services, among other examples.

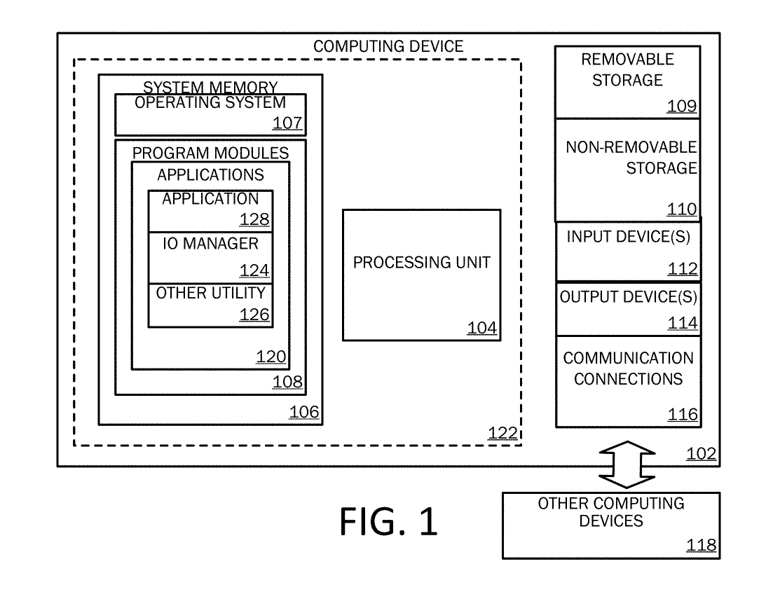

FIGS. 1-3 and the associated descriptions provide a discussion of a variety of operating environments in which examples of the invention may be practiced. However, the devices and systems illustrated and discussed with respect to FIGS. 1-3 are for purposes of example and illustration and are not limiting of a vast number of computing device configurations that may be utilized for practicing examples of the invention, described herein.

FIG. 1 is a block diagram illustrating physical components of a computing device 102, for example a mobile processing device, with which examples of the present disclosure may be practiced. Among other examples, computing device 102 may be an exemplary computing device configured for execution of data visualization, for example, within a service, as described herein. In a basic configuration, the computing device 102 may include at least one processing unit 104 and a system memory 106. Depending on the configuration and type of computing device, the system memory 106 may comprise, but is not limited to, volatile storage (e.g., random access memory), non-volatile storage (e.g., read-only memory), flash memory, or any combination of such memories. The system memory 106 may include an operating system 107 and one or more program modules 108 suitable for running software programs/modules 120 such as IO manager 124, other utility 126 and application 128. As examples, system memory 106 may store instructions for execution. Other examples of system memory 106 may store data associated with applications. The operating system 107, for example, may be suitable for controlling the operation of the computing device 102. Furthermore, examples of the invention may be practiced in conjunction with a graphics library, other operating systems, or any other application program and is not limited to any particular application or system. This basic configuration is illustrated in FIG. 1 by those components within a dashed line 122. The computing device 102 may have additional features or functionality. For example, the computing device 102 may also include additional data storage devices (removable and/or non-removable) such as, for example, magnetic disks, optical disks, or tape. Such additional storage is illustrated in FIG. 1 by a removable storage device 109 and a non-removable storage device 110.

As stated above, a number of program modules and data files may be stored in the system memory 106. While executing on the processing unit 104, program modules 108 (e.g., Input/Output (I/O) manager 124, other utility 126 and application 128) may perform processes including, but not limited to, one or more of the stages of the operations described throughout this disclosure. Other program modules that may be used in accordance with examples of the present invention may include electronic mail and contacts applications, word processing applications, spreadsheet applications, database applications, slide presentation applications, drawing or computer-aided application programs, photo editing applications, authoring applications, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 1 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing device 102 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

The computing device 102 may also have one or more input device(s) 112 such as a keyboard, a mouse, a pen, a sound input device, a device for voice input/recognition, a touch input device, etc. The output device(s) 114 such as a display, speakers, a printer, etc. may also be included. The aforementioned devices are examples and others may be used. The computing device 104 may include one or more communication connections 116 allowing communications with other computing devices 118. Examples of suitable communication connections 116 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 106, the removable storage device 109, and the non-removable storage device 110 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 102. Any such computer storage media may be part of the computing device 102. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

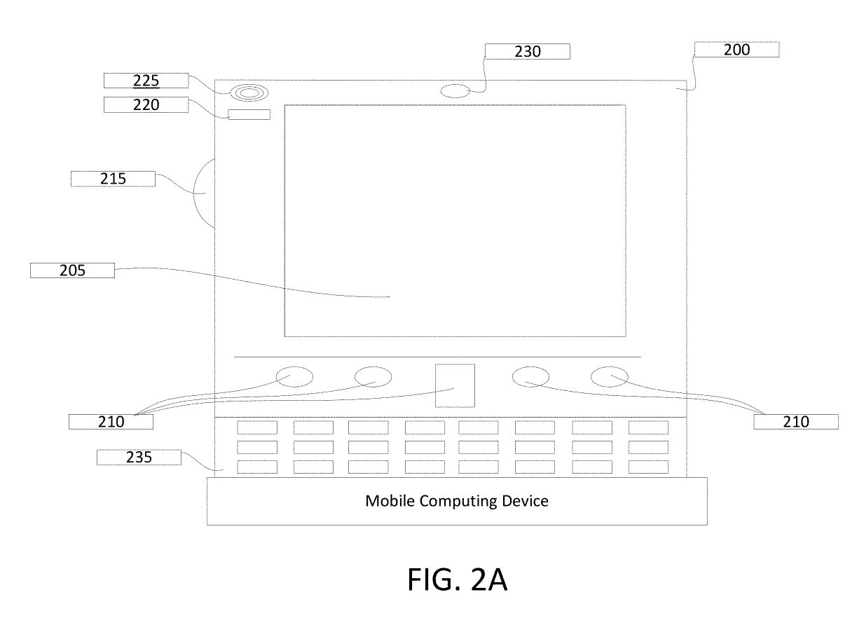

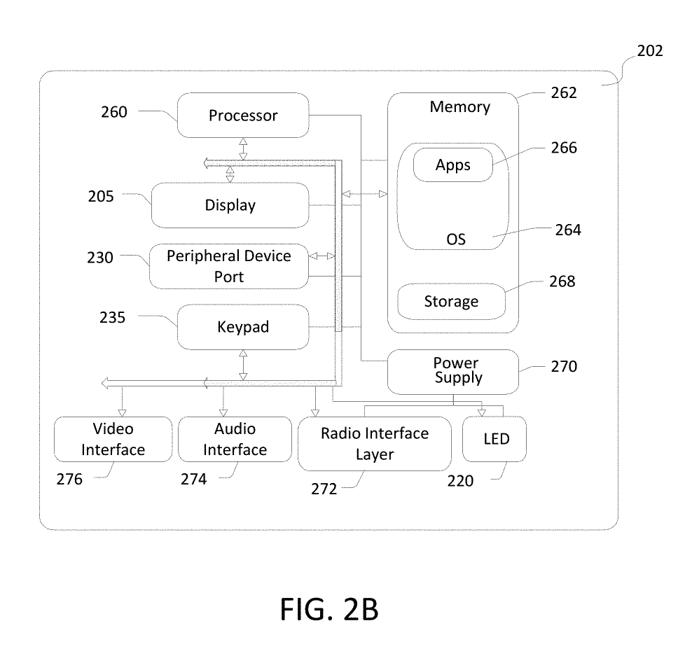

FIGS. 2A and 2B illustrate a mobile computing device 200, for example, a mobile telephone, a smart phone, a personal data assistant, a tablet personal computer, a phablet, a slate, a laptop computer, and the like, with which examples of the invention may be practiced. Mobile computing device 200 may be an exemplary computing device configured for execution of data visualization, for example, within a service, as described herein. Application command control may be provided for applications executing on a computing device such as mobile computing device 200. Application command control relates to presentation and control of commands for use with an application through a user interface (UI) or graphical user interface (GUI). In one example, application command controls may be programmed specifically to work with a single application. In other examples, application command controls may be programmed to work across more than one application. With reference to FIG. 2A, one example of a mobile computing device 200 for implementing the examples is illustrated. In a basic configuration, the mobile computing device 200 is a handheld computer having both input elements and output elements. The mobile computing device 200 typically includes a display 205 and one or more input buttons 210 that allow the user to enter information into the mobile computing device 200. The display 205 of the mobile computing device 200 may also function as an input device (e.g., touch screen display). If included, an optional side input element 215 allows further user input. The side input element 215 may be a rotary switch, a button, or any other type of manual input element. In alternative examples, mobile computing device 200 may incorporate more or less input elements. For example, the display 205 may not be a touch screen in some examples. In yet another alternative example, the mobile computing device 200 is a portable phone system, such as a cellular phone. The mobile computing device 200 may also include an optional keypad 235. Optional keypad 235 may be a physical keypad or a “soft” keypad generated on the touch screen display or any other soft input panel (SIP). In various examples, the output elements include the display 205 for showing a GUI, a visual indicator 220 (e.g., a light emitting diode), and/or an audio transducer 225 (e.g., a speaker). In some examples, the mobile computing device 200 incorporates a vibration transducer for providing the user with tactile feedback. In yet another example, the mobile computing device 200 incorporates input and/or output ports, such as an audio input (e.g., a microphone jack), an audio output (e.g., a headphone jack), and a video output (e.g., a HDMI port) for sending signals to or receiving signals from an external device.

FIG. 2B is a block diagram illustrating the architecture of one example of a mobile computing device. That is, the mobile computing device 200 can incorporate a system (i.e., an architecture) 202 to implement some examples. In one examples, the system 202 is implemented as a “smart phone” capable of running one or more applications (e.g., browser, e-mail, calendaring, contact managers, messaging clients, games, and media clients/players). In some examples, the system 202 is integrated as a computing device, such as an integrated personal digital assistant (PDA), tablet and wireless phone.

One or more application programs 266 may be loaded into the memory 262 and run on or in association with the operating system 264. Examples of the application programs include phone dialer programs, e-mail programs, personal information management (PIM) programs, word processing programs, spreadsheet programs, Internet browser programs, messaging programs, and so forth. The system 202 also includes a non-volatile storage area 268 within the memory 262. The non-volatile storage area 268 may be used to store persistent information that should not be lost if the system 202 is powered down. The application programs 266 may use and store information in the non-volatile storage area 268, such as e-mail or other messages used by an e-mail application, and the like. A synchronization application (not shown) also resides on the system 202 and is programmed to interact with a corresponding synchronization application resident on a host computer to keep the information stored in the non-volatile storage area 268 synchronized with corresponding information stored at the host computer. As should be appreciated, other applications may be loaded into the memory 262 and run on the mobile computing device (e.g. system 202) described herein.

The system 202 has a power supply 270, which may be implemented as one or more batteries. The power supply 270 might further include an external power source, such as an AC adapter or a powered docking cradle that supplements or recharges the batteries.

The system 202 may include peripheral device port 230 that performs the function of facilitating connectivity between system 202 and one or more peripheral devices. Transmissions to and from the peripheral device port 230 are conducted under control of the operating system (OS) 264. In other words, communications received by the peripheral device port 230 may be disseminated to the application programs 266 via the operating system 264, and vice versa.

The system 202 may also include a radio interface layer 272 that performs the function of transmitting and receiving radio frequency communications. The radio interface layer 272 facilitates wireless connectivity between the system 202 and the “outside world,” via a communications carrier or service provider. Transmissions to and from the radio interface layer 272 are conducted under control of the operating system 264. In other words, communications received by the radio interface layer 272 may be disseminated to the application programs 266 via the operating system 264, and vice versa.

The visual indicator 220 may be used to provide visual notifications, and/or an audio interface 274 may be used for producing audible notifications via the audio transducer 225 (as described in the description of mobile computing device 200). In the illustrated example, the visual indicator 220 is a light emitting diode (LED) and the audio transducer 225 is a speaker. These devices may be directly coupled to the power supply 270 so that when activated, they remain on for a duration dictated by the notification mechanism even though the processor 260 and other components might shut down for conserving battery power. The LED may be programmed to remain on indefinitely until the user takes action to indicate the powered-on status of the device. The audio interface 274 is used to provide audible signals to and receive audible signals from the user. For example, in addition to being coupled to the audio transducer 225 (shown in FIG. 2A), the audio interface 274 may also be coupled to a microphone to receive audible input, such as to facilitate a telephone conversation. In accordance with examples of the present invention, the microphone may also serve as an audio sensor to facilitate control of notifications, as will be described below. The system 202 may further include a video interface 276 that enables an operation of an on-board camera 230 to record still images, video stream, and the like.

A mobile computing device 200 implementing the system 202 may have additional features or functionality. For example, the mobile computing device 200 may also include additional data storage devices (removable and/or non-removable) such as, magnetic disks, optical disks, or tape. Such additional storage is illustrated in FIG. 2B by the non-volatile storage area 268.

Data/information generated or captured by the mobile computing device 200 and stored via the system 202 may be stored locally on the mobile computing device 200, as described above, or the data may be stored on any number of storage media that may be accessed by the device via the radio 272 or via a wired connection between the mobile computing device 200 and a separate computing device associated with the mobile computing device 200, for example, a server computer in a distributed computing network, such as the Internet. As should be appreciated such data/information may be accessed via the mobile computing device 200 via the radio 272 or via a distributed computing network. Similarly, such data/information may be readily transferred between computing devices for storage and use according to well-known data/information transfer and storage means, including electronic mail and collaborative data/information sharing systems.

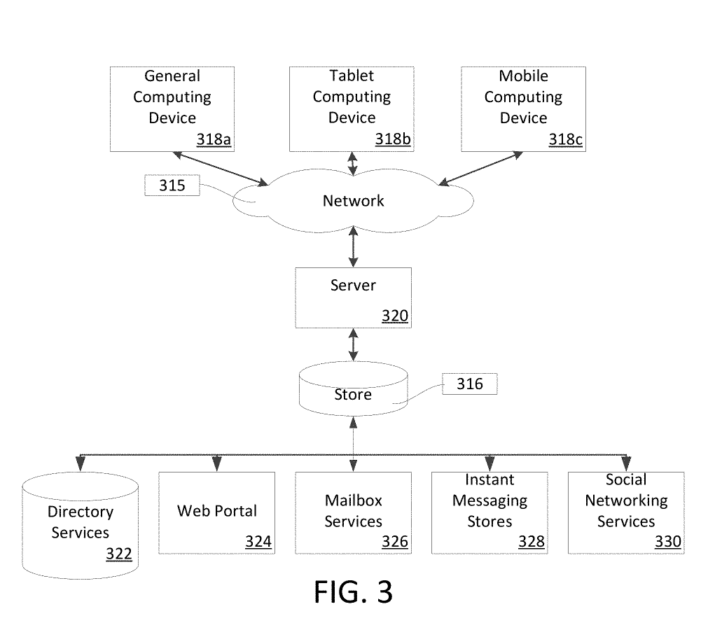

FIG. 3 illustrates one example of the architecture of a system for providing an application that reliably accesses target data on a storage system and handles communication failures to one or more client devices, as described above. The system of FIG. 3 may be an exemplary system configured for execution of data visualization, for example, within a service, as described herein. Target data accessed, interacted with, or edited in association with programming modules 108 and/or applications 120 and storage/memory (described in FIG. 1) may be stored in different communication channels or other storage types. For example, various documents may be stored using a directory service 322, a web portal 324, a mailbox service 326, an instant messaging store 328, or a social networking site 330, application 128, IO manager 124, other utility 126, and storage systems may use any of these types of systems or the like for enabling data utilization, as described herein. A server 320 may provide storage system for use by a client operating on general computing device 102 and mobile device(s) 200 through network 315. By way of example, network 315 may comprise the Internet or any other type of local or wide area network, and a client node may be implemented for connecting to network 315. Examples of a client node comprise but are not limited to: a computing device 102 embodied in a personal computer, a tablet computing device, and/or by a mobile computing device 200 (e.g., mobile processing device). As an example, a client node may connect to the network 315 using a wireless network connection (e.g. WiFi connection, Bluetooth, etc.). However, examples described herein may also extend to connecting to network 315 via a hardwire connection. Any of these examples of the client computing device 102 or 200 may obtain content from the store 316.

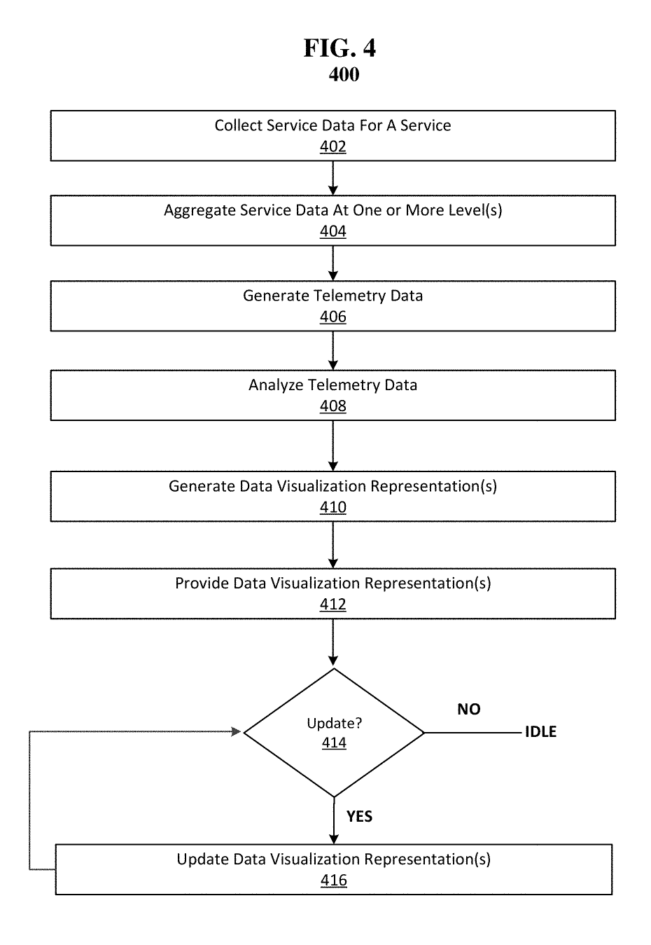

FIG. 4 provides examples of an exemplary method 400 related to management of an exemplary data visualization representation with which aspects of the present disclosure may be practiced. As an example, method 400 may be executed by an exemplary processing device and/or system such as those shown in FIGS. 1-3. In examples, method 400 may execute on a device comprising at least one processor configured to store and execute operations, programs or instructions. Operations performed in method 400 may correspond to operations executed by a system and/or service that execute computer programs, application programming interfaces (APIs), neural networks or machine-learning processing, among other examples. As an example, processing operations executed in method 400 may be performed by one or more hardware components. In another example, processing operations executed in method 400 may be performed by one or more software components. In some examples, processing operations described in method 400 may be executed by one or more applications/services associated with a web service that has access to a plurality of application/services, devices, knowledge resources, etc. Processing operations described in method 400 may be implemented by one or more components connected over a distributed network.

Method 400 begins at processing operation 402, where service data is collected pertaining to service data of a service. As an example, an exemplary service may be a distributed service that provides access to a variety of different types of content. Service data may be collected and analyzed through an exemplary data visualization service that may be natively integrated within a distributed service. An exemplary data visualization service comprises components for aggregating and analyzing service data of a service and generation and managing data visualization representations. In one example, the data visualization service comprises components that are built into operation of an exemplary service (e.g. baked in) where components are native to a service (e.g. not add-ons or third-party applications which are external to platform resources associated with a service). In this way, processing efficiency is improved (e.g. streamlining of components/access as well as updates) for data visualization processing, providing at least one example as to how the present disclosure differentiates from other data evaluation services that outsource data evaluation tools. In collecting (processing operation 402), service data for a service, components of an exemplary data visualization service either access or create a telemetry pipeline that tracks events and data (including signals) associated with a service.

The data visualization service may comprise a dashboard that is usable to collection of service data and generating telemetry data for the collected service data. The data visualization service enables developers to manage the collection and management of telemetry data through an exemplary dashboard.

Continuing flow of method 400, where collected service data is aggregated at one or more levels. In processing operation 404, collected service data may be aggregated at level to assist with generation of telemetry data that can be used to analyze the service data using a lens (e.g. user level, content level, group level, etc.). In some examples, an exemplary data visualization representation may comprise a visual representation of service data aggregated at different levels. In one instance, service data associated with different data channels can be aggregated at a group level and individual user level (e.g. for users associated with the group), where indications of points of interest can be utilized to identify different levels of aggregation.

Flow may proceed to processing operation 406, where telemetry data is generated for the aggregated service data. Telemetry data is data that is utilized to analyze service data of a service. In the process of generating the telemetry data, an exemplary data visualization service is configured to execute processing operations related to: polling incoming service data, aggregating the collected service data at one or more levels (e.g. user level, team level, data channel level, etc.), generating telemetry data for the aggregated service data and analyzing the generated telemetry data. As identified above, an exemplary data visualization service may comprise a telemetry data pipeline for processing operations related to generation of telemetry data. Computer applications/programs, code, scripts, functions, etc. may be used to collect service data, aggregate the service data and generate telemetry. In some examples, the data visualization service may extensibly interface with platform resources for telemetry data generation and processing. Telemetry data can be collected and analyzed for one or more specific points of interest (or points of interest across different channels). Telemetry data summarizes exemplary points of interest (e.g. per data channel, across data channels, per user of a group, for a group of users, etc.). Summary data may be generated for specific points of interest. Summary data may vary based on the type of content included in different data channels. One skilled in the art should recognize that developers can generate any type of summary data for a point of interest.

Flow may proceed to processing operation 408, where generated telemetry data is analyzed. Analysis (processing operation 408) of telemetry data may be used to generate an exemplary data visualization representation. A data visualization application/service may comprise one or more telemetry components that are configured to analyze various end points associated with a service, for example, to collect and analyze service data. Telemetry data can be collected and analyzed through any means including but not limited to: computer programs/scripts, application programming interfaces (APIs), neural networks and machine-learning processing, among other examples. An exemplary telemetry component may be further configured to parse telemetry data and evaluate the parsed telemetry data.

As an example, a telemetry component may apply rule sets used for analyzing (processing operation 408) telemetry data. Exemplary rules can be generated to analyze telemetry data in any type of context. For example, rules applied may be set at: a user specific level, a content specific level, a team specific level (or cross-team level), a channel specific level, a point-of-interest specific level, an entry point level, etc. An exemplary data visualization can be generated based on any of the above identified levels. In one example, rules are set to: evaluate telemetry data from multiple different levels, compare service data from the perspective of multiple different levels and generate an exemplary data visualization representation. In examples, rules are also set for the evaluation of aggregated service data, for example, where rules may be set to compare aggregated content in terms of priority and/or importance.

As an example, analysis (processing operation 408) of telemetry data may comprise analyzing specific content related to summary data. For example, a new message may be received, new content added, a new group associated with a user, content deleted, etc. Analysis of the telemetry data identifies content and notifications that can be pushed to a user through an exemplary data visualization representation. As an example, telemetry data may be analyzed at a level of a point of interest. However, the presented disclosure is not limited to such an example. Analysis of a point of interest may assist a data visualization service in determining: how to display a point of interest when an exemplary data visualization representation is generated as well as specific content to push for notification to a user (e.g. new message, upcoming meeting, tasks/reminders, etc.). Analysis of an exemplary point of interest may comprise but is not limited to: analyzing volume of content related to different endpoints (e.g. number of messages, number of task builds, updates to project milestones, etc.) as well as specific updates to content of endpoints (e.g. new message received, new version of code uploaded, etc.)

A channel is an example of a point of interest, where the channel may comprise one or more associated data streams. As an example, a channel may comprise data streams for a specific topic that is affiliated with a group/team (or cross-reference channels across groups/teams of a user). For instance, consider an example where a software development team is working on a software build. A channel may be created for communications related to the software build. As an example, the exemplary channel for a software build may comprise: profiles of team members, correspondence between team members (e.g. chats, text message, conversations, emails, etc.), content related to the software build (e.g. files/versions of code, task builds, comments, updates, etc.) and data for project management of the software build (e.g. task list, assignments, project milestones, process charts, etc.) among other examples. Using the data visualization service, service data of the channel (and other channels of the group/team) may be specifically targeted and analyzed. In further examples, points of interest related to the software development team may be illustrated along with points of interest across other data channels of a user.

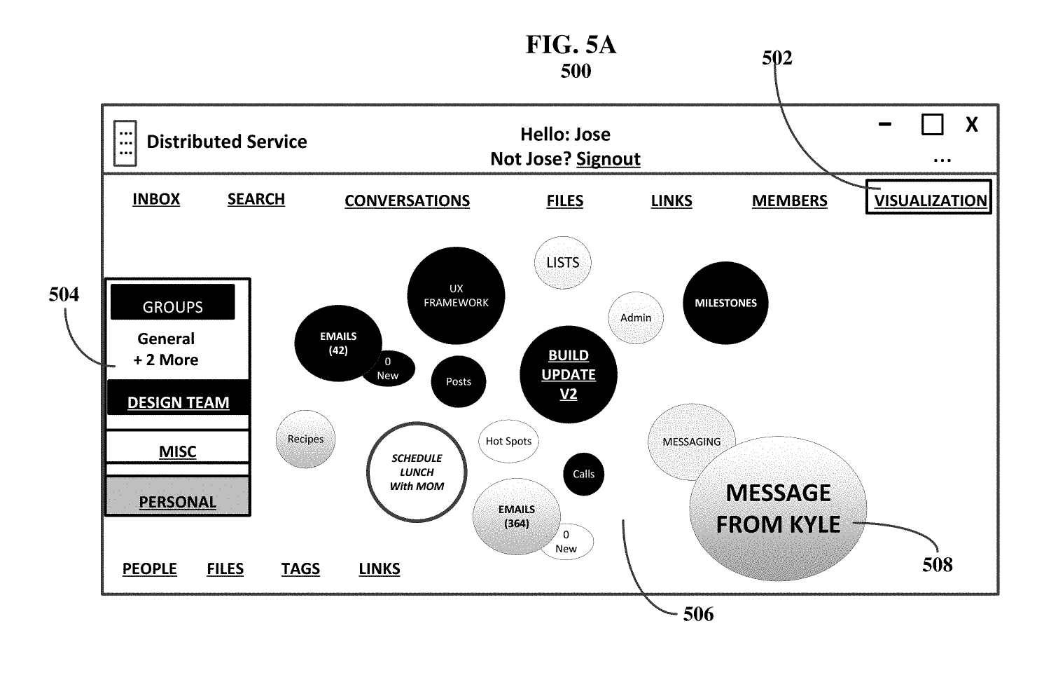

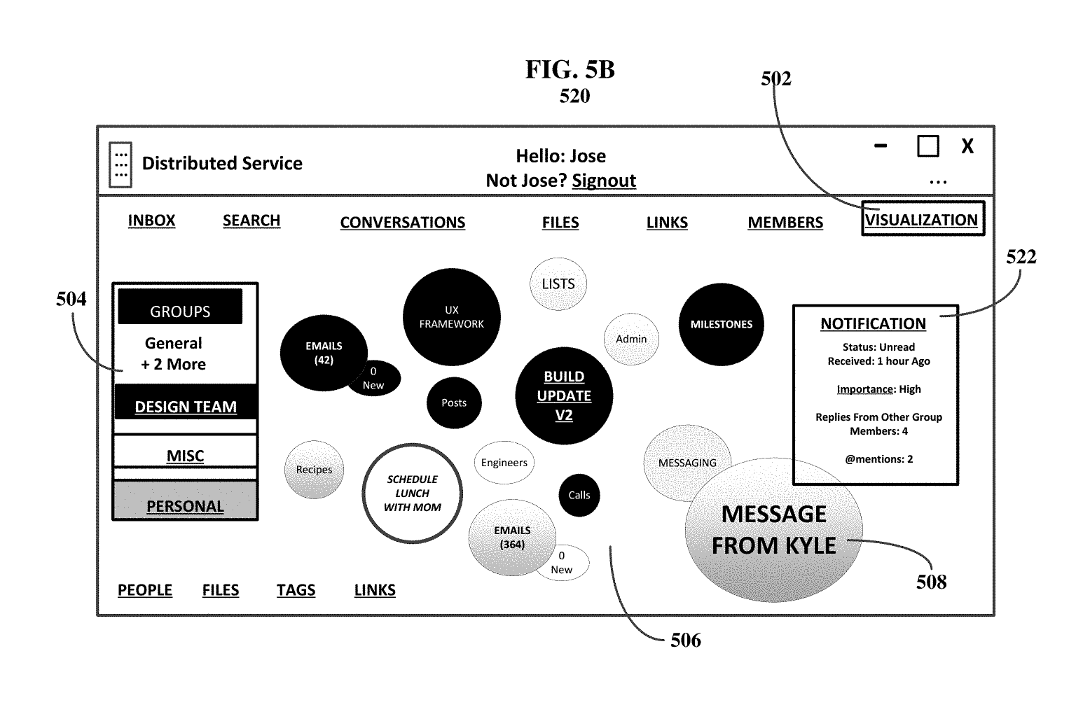

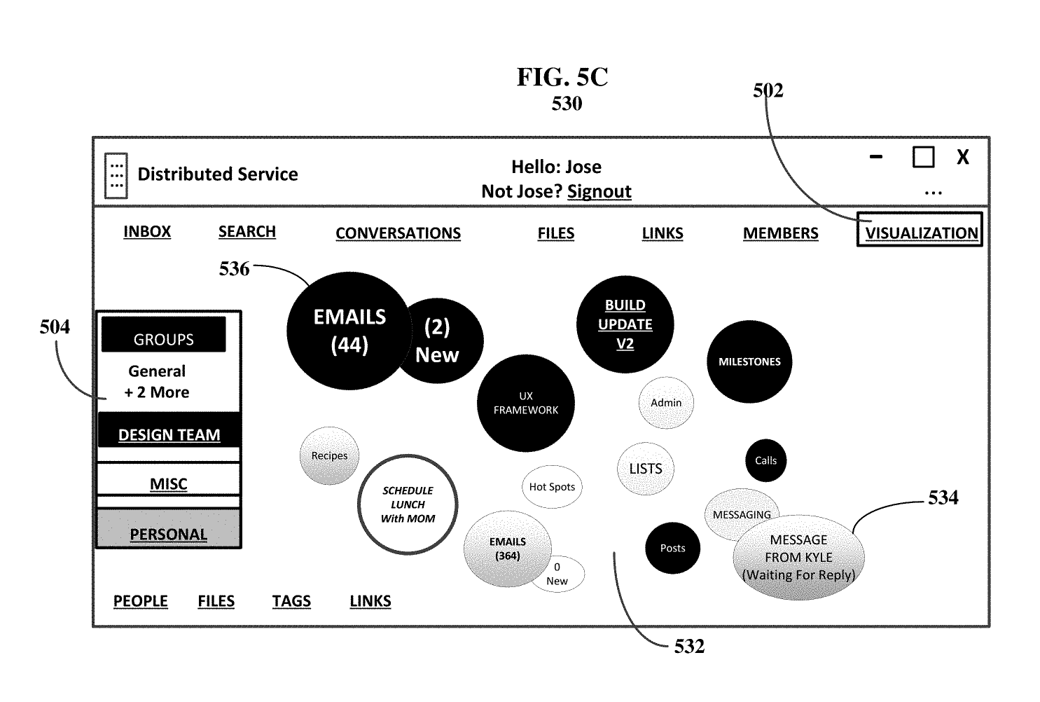

Based on analysis of different aspects of telemetry data and/or context of service data relating to the telemetry data, flow may proceed to processing operation 410 where one or more data visualization representations is generated. A data visualization representation may be generated (processing operation 410), which provides a way for a user to organize content of the service (e.g. content provided through a data channel). Illustrations pertaining to exemplary data visualization representations are provided in at least FIGS. 5A-5C.

As an example, an exemplary data visualization representation may present a visual representation of data of a service (e.g. service data) from the perspective of a user. The data visualization representation aggregates data of the service into points of interest that provide user-centric perspectives of the service data. Points of interest may comprise but not limited to: individual data streams, channels pertaining to groups and/or teams that a user is associated with, messages, postings, mentions, chats/conversations, emails, meetings/events, social networking connections, documents, task items, reminders, data storage and media content, among other examples. An exemplary data visualization representation may comprise one or more indications that pertain to specific points of interest that may be of interest to a user or group of users. An exemplary data visualization representation is designed (and configured) to organize a large volume of service data for the user, direct attention of the user to content that may be of importance to the user as well as enable a user to initiate an action through the data visualization representation. Generation of the data visualization representation may occur in real-time, providing a real-time perspective of data of a distributed service. In one example, a data visualization representation may be automatically generated based on a user signing-in (logging on) to a distributed service. In another example, a data visualization representation may be automatically generated based on a user interface selection by a user of a distributed service. In other instances, data visualization representations may be generated or updated based on an update to service data and/or re-aggregation of service data, re-generation of telemetry data and re-analysis of re-generated telemetry data.

As an illustrative example, a user may be associated with 3 different groups, where the data visualization generated provides cross-references to content from all 3 of the example groups within a single representation. An exemplary data visualization representation may comprise a plurality of indications of points of interest across one or more data channels (pertaining to one or more groups). The plurality of indications of points of interest may vary by one or more of: scale, visual depiction and orientation based on a result of the analysis of the telemetry data. For instance, indications of points of interest pertaining to a specific data channel, group, team, etc. may be one color and indications of points of interest for another data channel, group, team, etc. may be a different color. Points of interest within a respective categorization (e.g. user, group, team, etc.) may also vary in scale, shape, font, orientation, visual depiction, etc. based on whether a user is to be notified of a specific point of interest. That is, characteristics of an exemplary point of interest may be customizable to alter display of the data visualization representation, for example, bring a point of interest to the attention of a user.

In another example, an exemplary data visualization representation is provided to a team of users. For instance, the data visualization representation may be provided to the team of users through the distributed service or other communication resource (e.g. messaging application, email, social networking service, etc.).

An exemplary data visualization representation prioritizes actions for a user based on updates to content of the service. Notifications of update to an exemplary point of interest may be provided through the data visualization representation. Update to a data visualization representation may comprise re-generation of exemplary points of interest (e.g. where position, color, shape, scale, orientation, etc.) and/or display of new points of interest. Moreover, a user may interact with a data visualization representation, for example, where an exemplary data visualization representation is configured to enable a user to take subsequent action within a service based on a representation provided of the service data. That is, an exemplary point of interest is actionable, enabling a user to initiate subsequent action with respect to a point of interest/notification.

An exemplary data visualization representation provides a live, real-time view of different points of interest for the service in a manner that highlights areas that are most relevant to a specific user (or users). In one example, an exemplary data visualization representation may provide points of interest across different data channels associated with a user (e.g. different groups that a user is associated with). In examples, a point of interest may be automatically updated based on an update to service data or re-analysis of service data and/or collected telemetry data for a service. For instance, a user may select an exemplary point of interest or a notification provided through the data visualization representation, for example, to access content of the service.

In some examples, generation of a data visualization representation may further comprise evaluation of additional aspects related to a user account such as past user behavior, a current state of the user, location of the user, date/time information, etc. In examples, generated telemetry data may further contemplate additional information pertaining to a user account, which can be used in generation of a data visualization representation. An exemplary data visualization representation may be generated (processing operation 410) and/or modified based on user-specific data including updates to user specific-data associate with a user account. In one instance, an exemplary data visualization service may detect a pattern that a user/team of users is communicating mainly through a chat application provided by a service. In such an example, the data visualization service may generate/modify an exemplary data visualization representation to more prominently feature received messages through a chat application of the service. In another example, the data visualization service may identify that a user is communicates more frequently with certain users and may generate an exemplary data visualization representation to more prominently feature communicates with a specific user. It should be understood from the present disclosure that any type of data collected through telemetric analysis of service data can be used in generation/update of an exemplary data visualization representation.

Flow of method 400 may proceed to processing operation 412, where an exemplary data visualization representation may be provided. As an example, an exemplary data visualization representation may be provided (processing operation 412) through a user interface of a service. As an example, a service may be a distributed service that provides a collaborative user environment for a plurality of users.

In alternative examples, providing (processing operation 412) of a data visualization representation may comprise transmitting a data visualization representation for display in other applications/services. In one example, an exemplary data visualization representation is provided to the group of users of a service. For instance, the data visualization representation may be provided to the group of users through the distributed service or other communication resource (e.g. messaging application, email, social networking service, etc.).

As described above, an exemplary data visualization service may be natively integrated within an application/service. An exemplary data visualization representation be configured to act as an active dashboard to manage access to content of a service. For instance, an active dashboard may comprise one or more layers providing different levels of organization of service data that pertains to a specific user (or group of users). In one example, an active dashboard may provide a data visualization representation of a group channel. Among other features/functions, an exemplary active dashboard may identify through visual representation: users associated with a group, points of interest of a group (e.g. related to specific content, hashtags, mentions, posts messages, etc.), statistical organization of points of interest for the channel including but not limited to: files, hashtags, conversations, calendar items, mentions, task/to-do items, group associations, graphical representations of important data for a user (e.g. milestones, calendar items, amount of time that elapsed since a user responded to a particular message, etc.).

Flow may proceed to decision operation 414, where it is determined whether a depiction of an exemplary data visualization representation is to be updated. Update to service data may trigger an update to an exemplary data visualization representation. If no update to service data occurs, flow may branch NO and method 400 remains idle until subsequent processing is to be executed. In some cases, a view of an exemplary data visualization representation may be periodically updated even in cases where service data is not updated. An exemplary data visualization service may enable developers and/or users to manage updates to an exemplary data visualization representation.

In examples where a data visualization representation is to be updated, flow branches YES and proceeds to processing operation 416, where a data visualization representation is updated. As referenced above, an exemplary data visualization representation may be automatically updated based on an update to service data, for example, that is associated with one or more data channels of a distributed service. Update to a data visualization representation may result in reconfiguration and re-alignment of indications of points of interest from a previous version of a data visualization representation. In some examples, a new indication may be added where another indication of a point of interest may be removed. New data for a user that is associated with a service (e.g. content such as message, posting, email, etc.) may be received resulting in re-collection and re-analysis of the service data (and associated telemetry data). An updated data visualization representation may be generated based on re-analysis processing. In one example, update to a data visualization representation comprises re-generation of a data visualization representation. In some examples, user selection of particular content within a service may trigger update to an exemplary data visualization representation. For instance, a user may select a different type of view that may trigger update to a displayed data visualization representation. In other examples, a data visualization representation may be automatically updated based on an update to service data, for example, that is associated with one or more data channels of a distributed service. Updates to an exemplary data visualization representation may comprise but are not limited to: modifying the points of interest displayed (e.g. adding/deleting points of interest), modifying characteristics of displayed points of interest including position/location, providing a notification pertaining to one or more points of interest and adding cross-references to related service data (e.g. data channels), among other examples.

In one example, an exemplary data visualization representation may be automatically updated based on an update to service data, for example, that is associated with one or more data channels of a distributed service. For example, new content (e.g. message, posting, email, etc.) may be received resulting in re-collection and re-analysis of the service data (and associated telemetry data). An updated data visualization representation may be generated based on re-analysis processing, for example, re-analysis of generated telemetry data.

FIGS. 5A-5C are exemplary user interface views presenting exemplary data visualization representations with which aspects of the present disclosure may be practiced.

FIG. 5A provides user interface view 500, which presents an exemplary user interface for accessing a service (e.g. distributed service). User interface view 500 comprises selection of a data visualization user interface feature 502. As described in the foregoing, an exemplary data visualization representation can be generated at different analysis levels including at a user or content level. In one instance, a data visualization representation may be generated that cross-references group associations of a user (e.g. aggregates data streams/data channels across user groups). Data visualization representation 506 illustrates this concept.

Selection of a data visualization user interface feature 502 may trigger display of an exemplary data visualization representation 506. Furthermore, user interface view 500 comprises group user interface feature 504 that identifies different groups that a user account is affiliated with. As shown in group user interface feature 504, 3 group “Design Team”, “Misc” and “Personal”. A data visualization representation 506 may highlight points of interest across the 3 groups associated with a user. As an example, points of interest corresponding with a respective group may be color-coded for ease of identification. As seen in group user interface feature 504, respective groups are associated with individual colors (e.g. black, white, gray). Exemplary points of interest (e.g. point of interest 508) are similarly color-coded. For instance, point of interest 508 is gray colored indicating that point of interest 508 pertains to the “Personal” group (illustrated in group user interface feature 504).

Data visualization representation 506 comprises a plurality of indicates of points of interest, for example, that pertain to groups of a user. As illustrated in user interface view 500, indications of points of interest may vary, for example, based on analysis of telemetry data used to analyze points of interest (as described in the foregoing). Analysis of telemetry data for points of interest result in characteristics of the displayed points of interest to be manipulated. For instance, size, color, shape, orientation, font style/size, location/position, etc. may vary based on results of analyzing telemetry data associated with specific points of interest, data channels, specific content, etc.

As an example, point of interest 508 is prominently presented identifying that a user has a message from a user (Kyle) who is a personal contact associated with the “Personal” group. Analysis of telemetry data associated with specific message content may yield a determination that the message is important and should be brought to the attention of the user. Among other exemplary instances, determinations may be made that: the sender of the message (Kyle) may be a team leader, supervisor, etc., the content may be time-sensitive, multiple other team members may have already responded to the message, the user may not have responded to the message for a predetermined amount of time, etc.

FIG. 5B provides user interface view 520, which presents an exemplary user interface for accessing a service (e.g. distributed service). User interface view 520 comprises the data visualization user interface feature 502, group user interface feature 504 and the data visualization representation 506 (comprising a plurality of indications of points of interest including point of interest 508). User interface view 520 further illustrates an example where an explicit notification 522 is provided for the data visualization representation 506. Explicit notification 522 is just one example of an exemplary notification that may be provided for a data visualization representation.

As identified in the foregoing, an exemplary data visualization representation may comprise an explicit notification that corresponds to an indication of the plurality of indications of points of interest. In at least one instance, a notification is presented in a foremost layer of the data visualization representation. Explicit notification 522 illustrates such an example (e.g. where a notification is presented over point of interest 508). An exemplary point of interest may be more identifiable than other points of interest within a data visualization representation, where a user may select, scroll over, etc. a specific point of interest. An exemplary data visualization service may be configured to display the explicit notification 522, for example, based on user action. In other examples, explicit notifications may be automatically displayed when a data visualization representation is generated, for example, based on analysis of telemetry data.

Explicit notification 522 relates to point of interest 508, where explicit notification 522 may be tailored to the specific content of point of interest 508. For example, the explicit notification 522 may provide information that identifies why point of interest 508 is being brought to the attention of a user/group of users. For instance, explicit notification 522 may be designated as content that should be brought to the attention of the user based on factors including but not limited to: message status, receipt time, importance level, replies from other group members, social media associations (e.g. @mentions), etc. In some examples, a notification may be automatically pushed to a user based on generation of an exemplary data visualization representation. In other examples, a notification may be displayed when a user selects a point of interest (e.g. point of interest 508). Selection of a notification (e.g. explicit notification 522) or a point of interest (e.g. point of interest 508) may result in navigation to specific content of a service so that a user can immediately take action with respect to the content.

FIG. 5C provides user interface view 530, which presents an exemplary user interface for accessing a service (e.g. distributed service). User interface view 530 comprises the data visualization user interface feature 502, group user interface feature 504 and an updated data visualization representation 532 (comprising a plurality of indications of points of interest including point of interest 534 and point of interest 536). User interface view 530 illustrates an example where a data visualization representation has been regenerated. Point of interest 534 is an update to point of interest 508 (illustrated in FIG. 5A). As can be seen in user interface view 530, point of interest 534 is displayed less prominently than point of interest 508 (of FIG. 5A). further, point of interest 534 comprises a status update, where it is shown that a user is waiting for a reply from a user Kyle. For instance, data visualization representation 506 (of FIG. 5A) may have been utilized by a user to provide a response to a message from Kyle. Point of interest 534 shown in data visualization 532 illustrates a dynamic update to a state of a message thread with another user (Kyle).

Moreover, a comparison of data visualization representation 506 (FIG. 5A) and data visualization representation 532 (FIG. 5C) yields that point of interest 536 is displayed more prominently for a user. Point of interest 536 pertains to emails that are associated with a “Design” group. That is point of interest 536 pertains to a specific content stream in a specific data channel for a group (“Design” group). A group may comprise one or more data channels. Point of interest 536 identifies that new emails exist within a group thread for the “Design” group. Point of interest 536 may be actionable, where a user can initiate action to access the new email content, for example, directly from the data visualization representation 532. As an example, a user may select point of interest 536 to display an email component directly within an exemplary distributed service. In another example, a user may hover over point of interest 536 in order to display an explicit notification for point of interest 536. In one example, an explicit notification for point of interest 536 may comprise a preview of the new email content.

In some examples, an exemplary data visualization representation may comprise a visual representation of service data aggregated at different levels. In one instance, service data associated with different data channels can be aggregated at a group level and individual user level (e.g. for users associated with the group), where indications of points of interest can be utilized to identify different levels of aggregation. In at least one example, an exemplary data visualization representation may be adjustable where multiple views may be generated for a single data visualization representation. A data visualization representation may be configured to enable a user to select different view of a data visualization representation, for example, a group level view, a user level view, a content specific view, etc. Furthermore, users can drill into specific data channels/streams, content, user profiles, etc. that may be associated with a data visualization representation.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While sample examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

What is claimed is:

1. A method comprising:
collecting service data associated with a distributed service, wherein the service data comprises data from a plurality of data channels that are associated with a user;
aggregating the service data at a group level, wherein the aggregating aggregates the plurality of data channels across groups that the user is associated with;
generating telemetry data for the aggregated service data;
analyzing the telemetry data; and
generating a data visualization representation that is tailored for the user based on an analysis of the telemetry data, wherein the data visualization representation comprises a plurality of indications of points of interest across the one or more data channels, and wherein the plurality of indications of points of interest are actionable links.

2. The method of claim 1, wherein the generating automatically generates the data visualization representation in real-time for the user based on analysis of the telemetry data.

3. The method of claim 2, wherein the data visualization representation is automatically generated for the user based on one or more selected from a group consisting of: sign-in to the distributed service and a selection through a user interface of the distributed service.

4. The method of claim 1, wherein the plurality of indication of points of interest vary by one or more of: scale, visual depiction and orientation based on a result of the analysis of the telemetry data.

5. The method of claim 4, wherein the aggregating further comprises aggregating the service data at multiple levels including the group level and a user level, and wherein the plurality of indication of points of interest vary to represent the multiple levels of aggregation.

6. The method of claim 4, further comprising: receiving an update to the service data and automatically re-generating the data visualization representation based on the update to the service data, wherein the re-generating comprises re-configuring the plurality of indications of points of interest, and wherein the re-configuring comprises one or more selected from a group consisting of: modifying one or more of the plurality of indications of points of interest, adding, to the plurality of indications of points of interest, a new indication for a new point of interest and removing, from the plurality of indications of points of interest, an indication.

7. The method of claim 1, further comprising: receiving an update to the service data, re-aggregating the service data based on the received update, re-generating the telemetry data based on a re-aggregation of the service data, re-analyzing the re-generated telemetry data and re-generating the data visualization representation based on a re-analysis of the re-generated telemetry data.

8. A system comprising:
at least one processor; and
a memory operatively connected with the at least one processor storing computer-executable instructions that, when executed by the at least one processor, causes the at least one processor to execute a method that comprises:
collecting service data associated with a distributed service, wherein the service data comprises data from a plurality of data channels that are associated with a user,
aggregating the service data at a group level, wherein the aggregating aggregates the plurality of data channels across groups that the user is associated with,
generating telemetry data for the aggregated service data,
analyzing the telemetry data, and
generating a data visualization representation that is tailored for the user based on an analysis of the telemetry data, wherein the data visualization representation comprises a plurality of indications of points of interest across the one or more data channels, and wherein the plurality of indications of points of interest are actionable links.

9. The system of claim 8, wherein the generating automatically generates the data visualization representation in real-time for the user based on analysis of the telemetry data.

10. The system of claim 9, wherein the data visualization representation is automatically generated for the user based on one or more selected from a group consisting of: sign-in to the distributed service and a selection through a user interface of the distributed service.

11. The system of claim 8, wherein the plurality of indication of points of interest vary by one or more of: scale, visual depiction and orientation based on a result of the analysis of the telemetry data.

12. The system of claim 11, wherein the aggregating further comprises aggregating the service data at multiple levels including the group level and a user level, and wherein the plurality of indication of points of interest vary to represent the multiple levels of aggregation.

13. The system of claim 11, wherein the executed method further comprises: receiving an update to the service data and automatically re-generating the data visualization representation based on the update to the service data, wherein the re-generating comprises re-configuring the plurality of indications of points of interest, and wherein the re-configuring comprises one or more selected from a group consisting of: modifying one or more of the plurality of indications of points of interest, adding, to the plurality of indications of points of interest, a new indication for a new point of interest and removing, from the plurality of indications of points of interest, an indication.

14. The system of claim 8, wherein the executed method further comprises: receiving an update to the service data, re-aggregating the service data based on the received update, re-generating the telemetry data based on a re-aggregation of the service data, re-analyzing the re-generated telemetry data and re-generating the data visualization representation based on a re-analysis of the re-generated telemetry data.

15. A computer-readable medium storing computer-executable instructions that, when executed by at least one processor, causes the at least one processor to execute a method comprising:
collecting service data associated with a distributed service, wherein the service data comprises data from a plurality of data channels that are associated with a user;
aggregating the service data at a group level, wherein the aggregating aggregates the plurality of data channels across groups that the user is associated with;
generating telemetry data for the aggregated service data;
analyzing the telemetry data; and
generating a data visualization representation that is tailored for the user based on an analysis of the telemetry data, wherein the data visualization representation comprises a plurality of indications of points of interest across the one or more data channels, and wherein the plurality of indications of points of interest are actionable links.

16. The computer-readable medium of claim 15, wherein the generating automatically generates the data visualization representation in real-time for the user based on analysis of the telemetry data, and wherein the data visualization representation is automatically generated for the user based on one or more selected from a group consisting of: sign-in to the distributed service and a selection through a user interface of the distributed service.

17. The computer-readable medium of claim 15, wherein the plurality of indication of points of interest vary by one or more of: scale, visual depiction and orientation based on a result of the analysis of the telemetry data.

18. The computer-readable medium of claim 17, wherein the aggregating further comprises aggregating the service data at multiple levels including the group level and a user level, and wherein the plurality of indication of points of interest vary to represent the multiple levels of aggregation.

19. The computer-readable medium of claim 17, wherein the method further comprising: receiving an update to the service data and automatically re-generating the data visualization representation based on the update to the service data, wherein the re-generating comprises re-configuring the plurality of indications of points of interest, and wherein the re-configuring comprises one or more selected from a group consisting of: modifying one or more of the plurality of indications of points of interest, adding, to the plurality of indications of points of interest, a new indication for a new point of interest and removing, from the plurality of indications of points of interest, an indication.

20. The computer-readable medium of claim 15, wherein the method further comprising: receiving an update to the service data, re-aggregating the service data based on the received update, re-generating the telemetry data based on a re-aggregation of the service data, re-analyzing the re-generated telemetry data and re-generating the data visualization representation based on a re-analysis of the re-generated telemetry data.
